(19) United States
(12) Patent Application Publication
(10) Pub. No.: US 2026/0342260 A1
(43) Pub. Date: Oct. 29, 2026

(54) Motor Control Method and Apparatus

(71) Applicant: Siemens Aktiengesellschaft, München (DE)

(72) Inventors: Wei Rong, Peking, BJ (CN); Zhong Quan Zhang, Peking, BJ (CN); Xiu Juan Yue, Peking, BJ (CN)

(73) Assignee: Siemens Aktiengesellschaft, München (DE)

(21) Appl. No.: 19/491,104

(22) PCT Filed: Jun. 5, 2024
(86) PCT No.: PCT/EP2024/065389

§ 371 Date: Dec. 8, 2025

(30) Foreign Application Priority Data
Jun. 6, 2023 (CN) 202310666232.X

(51) Int. Cl. H02P 25/024; H02P 6/08; H02P 23/14

(52) U.S. Cl. CPC H02P 25/024; H02P 6/08; H02P 23/14; H02P 2207/05

(57) ABSTRACT

Various embodiments include a motor control method. An example includes: acquiring a reactive current mean value of a permanent magnet synchronous motor; using a first output voltage corresponding to a target frequency to drive the permanent magnet synchronous motor to operate; detecting a first reactive current value during operation of the permanent magnet synchronous motor; adjusting the first output voltage according to the first reactive current value and the reactive current mean value to obtain a second output voltage; and using the second output voltage to drive the permanent magnet synchronous motor to operate.

### CROSS-REFERENCE TO RELATED APPLICATIONS

This application is a U.S. National Stage Application of International Application No. PCT/EP2024/065389 filed Jun. 5, 2024, which designates the United States of America, and claims priority to CN Application No. 202310666232.X filed Jun. 6, 2023, the contents of which are hereby incorporated by reference in their entirety.

### TECHNICAL FIELD

The present disclosure relates to electric control. Various embodiments of the teachings herein include motor control methods and apparatus.

### BACKGROUND

Permanent magnet synchronous motors provide high power efficiency, high power factor, and small volume, and also have low rotational inertia, allowing high pulse torque, and are therefore capable of attaining high acceleration. Permanent magnet synchronous motors have good dynamic performance, are structurally compact and highly reliable in operation, while also being structurally simple and easy to maintain. As a result, permanent magnet synchronous motors are widely used in production as well as everyday life.

At present, frequency converters employ vector control or programmable V/F control to drive permanent magnet synchronous motors. However, the use of vector control to drive a permanent magnet synchronous motor is expensive, and when programmable V/F control is used, adjustment/testing is difficult due to the large number of types of permanent magnet synchronous motors and loads. Moreover, load changes easily cause permanent magnet synchronous motors to fall out of step, and permanent magnet synchronous motors have poor stability. Thus, existing motor control methods are not very practical.

### SUMMARY

In view of the above, the motor control methods and apparatus provided in the present application can prevent a permanent magnet synchronous motor from falling out of step and are thus highly practical. As an example, some embodiments include a motor control method comprising: acquiring a reactive current mean value of a permanent magnet synchronous motor; using a first output voltage corresponding to a target frequency to drive the permanent magnet synchronous motor to operate; detecting a first reactive current value during operation of the permanent magnet synchronous motor; adjusting the first output voltage according to the first reactive current value and the reactive current mean value to obtain a second output voltage, and using the second output voltage to drive the permanent magnet synchronous motor to operate.

In some embodiments, acquiring a reactive current mean value of a permanent magnet synchronous motor comprises: acquiring a rated operating frequency of the permanent magnet synchronous motor; controlling the permanent magnet synchronous motor to operate at a first frequency, wherein the ratio of the first frequency to the rated operating frequency is a preset ratio threshold less than or equal to 1; detecting a reactive current of the permanent magnet synchronous motor, to obtain at least two second reactive current values; determining a mean value of the at least two second reactive current values to be the reactive current mean value.

In some embodiments, the ratio threshold is 1/2.

In some embodiments, using a first output voltage corresponding to a target frequency to drive the permanent magnet synchronous motor to operate comprises: acquiring a rated back emf voltage of the permanent magnet synchronous motor; determining the first output voltage corresponding to the target frequency according to a linear relationship between the rated operating frequency and the rated back emf voltage; using the first output voltage to drive the permanent magnet synchronous motor to operate, wherein the first output voltage is less than or equal to the rated back emf voltage.

In some embodiments, adjusting the first output voltage according to the first reactive current value and the reactive current mean value to obtain a second output voltage, and using the second output voltage to drive the permanent magnet synchronous motor to operate, comprises: if the difference between the first reactive current value and the reactive current mean value lies within a preset range of fluctuation, determining the first output voltage to be the second output voltage, and using the second output voltage to drive the permanent magnet synchronous motor to operate.

In some embodiments, adjusting the first output voltage according to the first reactive current value and the reactive current mean value to obtain a second output voltage, and using the second output voltage to drive the permanent magnet synchronous motor to operate, comprises: if the difference between the first reactive current value and the reactive current mean value is greater than a first threshold, reducing the first output voltage to obtain the second output voltage, and using the second output voltage to drive the permanent magnet synchronous motor to operate.

In some embodiments, adjusting the first output voltage according to the first reactive current value and the reactive current mean value to obtain a second output voltage, and using the second output voltage to drive the permanent magnet synchronous motor to operate, comprises: if the difference between the first reactive current value and the reactive current mean value is less than a second threshold, increasing the first output voltage to obtain the second output voltage, and using the second output voltage to drive the permanent magnet synchronous motor to operate.

As another example, some embodiments include a motor control apparatus comprising: an acquisition unit, for acquiring a reactive current mean value of a permanent magnet synchronous motor; a first drive unit, for using a first output voltage corresponding to a target frequency to drive the permanent magnet synchronous motor to operate; a detection unit, for detecting a first reactive current value during operation of the permanent magnet synchronous motor; a second drive unit, for adjusting the first output voltage according to the first reactive current value and the reactive current mean value to obtain a second output voltage, and using the second output voltage to drive the permanent magnet synchronous motor to operate.

As another example, some embodiments include an electronic device comprising: a processor, a communication interface, a memory and a communication bus, the processor, the memory and the communication interface communicating with each other via the communication bus; the memory being configured to store at least one executable instruction, the executable instruction causing the processor to perform one or more of the motor control methods described herein.

As another example, some embodiments include a computer-readable storage medium storing thereon a computer instruction which, when executed by a processor, causes the processor to perform one or more of the motor control methods described herein.

As another example, some embodiments include a computer program product stored on a tangible computer-readable medium comprising a computer-executable instruction which, when executed, causes at least one processor to perform one or more of the motor control methods provided herein.

### BRIEF DESCRIPTION OF THE DRAWINGS

FIG. 1 is a flow chart of an example motor control method incorporating teachings of the present application;

FIG. 2 is a flow chart of an example method incorporating teachings of the present application for acquiring a reactive current mean value;

FIG. 3 is a flow chart of an example motor control method incorporating teachings of the present application;

FIG. 4 is a schematic drawing of an example motor control apparatus incorporating teachings of the present application; and

FIG. 5 is a schematic drawing of an example electronic device incorporating teachings of the present application.

### KEY TO THE DRAWINGS

101: acquiring a reactive current mean value of a permanent magnet synchronous motor

102: using a first output voltage corresponding to a target frequency to drive the permanent magnet synchronous motor to operate

103: detecting a first reactive current value during operation of the permanent magnet synchronous motor

104: adjusting the first output voltage according to the first reactive current value and the reactive current mean value to obtain a second output voltage, and using the second output voltage to drive the permanent magnet synchronous motor to operate

201: acquiring a rated operating frequency of the permanent magnet synchronous motor

202: controlling the permanent magnet synchronous motor to operate at a first frequency

203: detecting a reactive current of the permanent magnet synchronous motor, to obtain at least two second reactive current

204: determining a mean value of the at least two second reactive current values to be the reactive current mean value 301: calculating the difference between the first reactive current value and the reactive current mean value

302: judging whether the difference between the first reactive current value and the reactive current mean value is greater than a first threshold

303: reducing the first output voltage to obtain a second output voltage, and using the second output voltage to drive the permanent magnet synchronous motor to operate

304: judging whether the difference between the first reactive current value and the reactive current mean value is less than a second threshold

305: increasing the first output voltage to obtain a second output voltage, and using the second output voltage to drive the permanent magnet synchronous motor to operate

100: Motor control

200: Method for

300: Another motor method acquiring reactive control method current mean value

401: Acquisition

402: First drive unit

403: Detection unit unit

404: Second drive

500: Electronic

502: Processor unit device

504: Communication

506: Memory

508: Communication interface bus

510: Program

400: Motor control apparatus

### DETAILED DESCRIPTION

By means of the teachings of the present disclosure, a first output voltage is used to drive a permanent magnet synchronous motor to operate, and in this way, independent voltage control of the permanent magnet synchronous motor is possible. The permanent magnet synchronous motor can be controlled more accurately to operate at a target frequency, and the first output voltage is adjusted according to a first reactive current detected during operation of the permanent magnet synchronous motor and an acquired reactive current mean value; thus, a drive voltage of the permanent magnet synchronous motor can be adjusted, so that the operation of the permanent magnet synchronous motor is more stable. Since a non-vector control method is used to drive the permanent magnet synchronous motor, the cost is lower, and when the load changes, the output voltage (i.e. the drive voltage of the permanent magnet synchronous motor) can be changed automatically according to the reactive current value produced by the permanent magnet synchronous motor. Thus, the permanent magnet synchronous motor can be prevented from falling out of step, and stability is higher, so the motor control method is more practical.

As stated above, permanent magnet synchronous motors have the advantages of high power efficiency, high power factor and small volume, and also have low rotational inertia, allowing high pulse torque, and are therefore capable of attaining high acceleration. Permanent magnet synchronous motors have good dynamic performance, are structurally compact and highly reliable in operation, while also being structurally simple and easy to maintain. As a result, permanent magnet synchronous motors are widely used in production as well as everyday life.

At present, frequency converters employ vector control or programmable V/F control to drive permanent magnet synchronous motors. However, in the case of wind turbine and water pump type loads with quadratic torque load characteristics, the use of a large number of vector frequency converters to drive permanent magnet synchronous motors by vector control is expensive. Moreover, when programmable V/F control is used to drive a permanent magnet synchronous motor, the method of programmable V/F control is a minimum current method, in which a voltage value at an optimum operating point is found, and a V/F curve between voltage and frequency is determined according to the voltage value at the optimum operating point, and the permanent magnet synchronous motor is driven by means of the V/F curve. However, such a method has the following shortcomings: when the load changes, the optimum operating point also changes, and the use of the original V/F curve to drive the permanent magnet synchronous motor is likely to cause the permanent magnet synchronous motor to fall out of step. Permanent magnet synchronous motors have poor stability, and are difficult to adjust/test, So the adjustment/testing time is long. Thus, existing permanent magnet synchronous motor control methods are not very practical.

In some embodiments, a first output voltage is used to drive a permanent magnet synchronous motor to operate, and in this way, independent voltage control of the permanent magnet synchronous motor is possible. The permanent magnet synchronous motor can be controlled more accurately to operate at a target frequency, and the first output voltage is adjusted according to a first reactive current detected during operation of the permanent magnet synchronous motor and an acquired reactive current mean value; thus, a drive voltage of the permanent magnet synchronous motor can be adjusted, so that the operation of the permanent magnet synchronous motor is more stable. Since a non-vector control method is used to drive the permanent magnet synchronous motor, the cost is lower, and when the load changes, the output voltage (i.e. the drive voltage of the permanent magnet synchronous motor) can be changed automatically according to the reactive current value produced by the permanent magnet synchronous motor. Thus, the permanent magnet synchronous motor can be prevented from falling out of step, and stability is higher, so the motor control method is more practical.

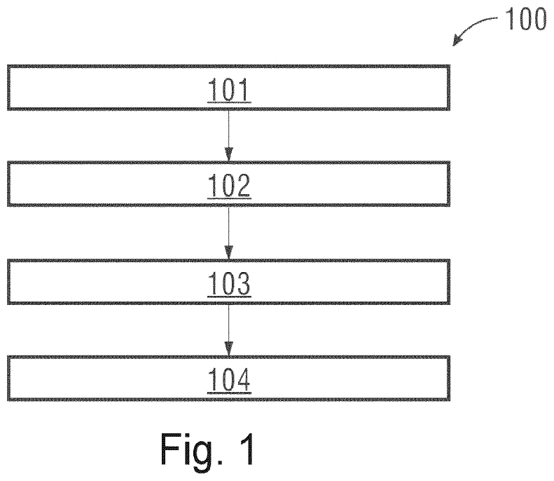

FIG. 1 is a flow chart of an example motor control method incorporating teachings of the present application. As shown in FIG. 1, the motor control method 100 comprises elements 101-104:

Step 101: acquiring a reactive current mean value of a permanent magnet synchronous motor. A reactive current mean value of a permanent magnet synchronous motor connected to a frequency converter is acquired.

In some embodiments, it is possible to judge whether a reactive current mean value has been calculated in advance for the permanent magnet synchronous motor; if so, the reactive current mean value calculated in advance is acquired, otherwise a reactive current mean value of the permanent magnet synchronous motor is calculated, and the calculated reactive current mean value is acquired, wherein the reactive current mean value may be calculated by an integral calculation method, a mean value method or another calculation method, and the specific calculation method is not limited by embodiments of the present application.

Step 102: using a first output voltage corresponding to a target frequency to drive the permanent magnet synchronous motor to operate. The target frequency is a preset operating frequency of the permanent magnet synchronous motor, i.e. the permanent magnet synchronous motor is required to operate at the target frequency; in embodiments of the present application, the permanent magnet synchronous motor drive method is independent voltage drive, i.e. the frequency converter controls the operation of the permanent magnet synchronous motor by changing the output voltage.

The frequency converter determines the first output voltage corresponding to the target frequency, and drives the permanent magnet synchronous motor to operate by means of the first output voltage, so that the permanent magnet synchronous motor operates at the target frequency.

Step 103: detecting a first reactive current value during operation of the permanent magnet synchronous motor. A first reactive current value arising during operation of the permanent magnet synchronous motor is detected; specifically, a drive current during operation of the permanent magnet synchronous motor may be split orthogonally into two current components at a first output voltage phase angle, wherein one current component has the same phase as the voltage, and the other current component is 90° from the voltage phase angle. The current component which has the same phase as the voltage is active current, and the current component which is 90° from the voltage phase angle is reactive current; and a first reactive current value of the reactive current is read. It should be understood that only one example of a method for detecting reactive current is shown above, and this should not be regarded as limiting the method for detecting reactive current in embodiments of the present application in any way.

Step 104: adjusting the first output voltage according to the first reactive current value and the reactive current mean value to obtain a second output voltage, and using the second output voltage to drive the permanent magnet synchronous motor to operate. The first output voltage is adjusted according to the first reactive current value and the reactive current mean value, the process of adjustment comprising increasing the first output voltage, decreasing the first output voltage v and maintaining the first output voltage, and the permanent magnet synchronous motor is driven to operate according to the second output voltage obtained by adjustment.

The process of adjusting the first output voltage is a dynamic adjustment process, e.g. after using the second output voltage to drive the permanent magnet synchronous motor, step 103 of detecting a first reactive current value during operation of the permanent magnet synchronous motor is performed again, and the second output voltage is adjusted according to the new first reactive current and the reactive current mean value; and this process is repeated.

In some embodiments, a first output voltage is used to drive a permanent magnet synchronous motor to operate, and in this way, independent voltage control of the permanent magnet synchronous motor is possible. The permanent magnet synchronous motor can be controlled more accurately to operate at a target frequency, and the first output voltage is adjusted according to a first reactive current detected during operation of the permanent magnet synchronous motor and an acquired reactive current mean value; thus, a drive voltage of the permanent magnet synchronous motor can be adjusted, so that the operation of the permanent magnet synchronous motor is more stable. Since a non-vector control method is used to drive the permanent magnet synchronous motor, the cost is lower, and when the load changes, the output voltage (i.e. the drive voltage of the permanent magnet synchronous motor) can be changed automatically according to the reactive current value produced by the permanent magnet synchronous motor. Thus, the permanent magnet synchronous motor can be prevented from falling out of step, and stability is higher, so the motor control method is more practical.

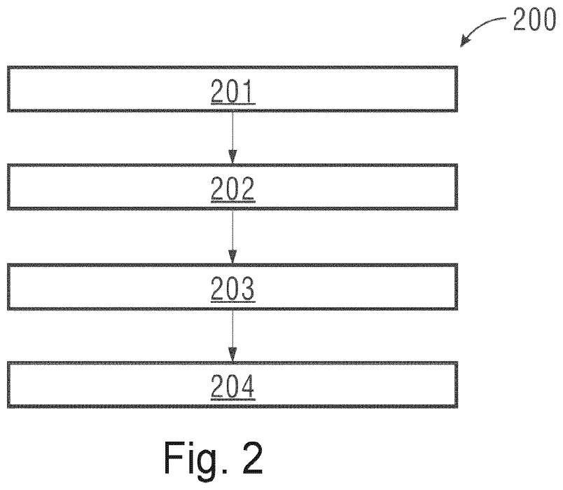

FIG. 2 is a flow chart of an example method incorporating teachings of the present disclosure for acquiring a reactive current mean value; as shown in FIG. 2, when acquiring a reactive current mean value of the permanent magnet synchronous motor, 201-204 below may be performed:

Step 201: acquiring a rated operating frequency of the permanent magnet synchronous motor. The rated operating frequency of the permanent magnet synchronous motor is acquired; this rated operating frequency is recorded on a motor nameplate. The rated operating frequency recorded on the nameplate may be inputted manually. It should be explained that when the rated operating frequency of the permanent magnet synchronous motor is not recorded on the motor nameplate, a rated rotation speed of the permanent magnet synchronous motor may be acquired, and the rated operating frequency of the permanent magnet synchronous motor may be calculated according to the formula \hat{ }=60\hat{ }/\hat{ }, where \hat{ } is used to represent the rated rotation speed of the permanent magnet synchronous motor, \hat{ } is used to represent the rated operating frequency of the permanent magnet synchronous motor, and \hat{ } is used to represent the number of pole pairs of the rotating magnetic field in the permanent magnet synchronous motor.

Step 202: controlling the permanent magnet synchronous motor to operate at a first frequency. The permanent magnet synchronous motor is controlled to operate at the first frequency; in embodiments of the present application, a V/F control method is used to drive the permanent magnet synchronous motor to operate at the first frequency, wherein the ratio of the first frequency to the rated operating frequency is a preset ratio threshold less than or equal to 1, for example: the ratio threshold may be ¼, i.e. the first frequency is ¼ of the rated frequency, and when the ratio threshold is 1, the permanent magnet synchronous motor is driven to operate at the rated frequency.

Step 203: detecting a reactive current of the permanent magnet synchronous motor, to obtain at least two second reactive current values. When operation of the permanent magnet synchronous motor reaches the first frequency, and operates stably at the first frequency, a reactive current of the permanent magnet synchronous motor at this time is detected at least twice, to obtain at least two reactive current values.

Step 204: determining a mean value of the at least two second reactive current values to be the reactive current mean value. The mean value of the at least two second reactive current values is calculated; in embodiments of the present application, various calculation methods can be used to calculate the mean value, for example: if there are a second reactive current 1 and a second reactive current 2, then the mean value is calculated according to the formula (second reactive current 1+second reactive current 2)/2 or the mean value is calculated by a geometric mean value calculation method, etc.

The calculated mean value of the at least two second reactive currents is determined to be the reactive current mean value, which is recorded.

In some embodiments, the permanent magnet synchronous motor is controlled to operate at the first frequency, the second reactive currents arising during operation of the permanent magnet synchronous motor are detected multiple times, and the mean value of the second reactive currents is determined to be the reactive current mean value. In this way, the reactive current mean value can be acquired. Moreover, since the reactive current mean value is the mean value of multiple reactive currents arising during operation at a fixed frequency, the reactive current mean value is more accurate and has higher reference significance; thus, when the first output voltage is adjusted according to the reactive current mean value and the first reactive current value, operation of the permanent magnet synchronous motor can be made more stable, so the method is more practical.

In some embodiments, the ratio threshold is 1/2.

In some embodiments, the ratio of the first frequency to the rated operating frequency is 1:2, i.e. the permanent magnet synchronous motor is controlled to operate at 1/2 of the rated frequency; in this case, the reactive current mean value calculated according to multiple second reactive currents produced by operation of the permanent magnet synchronous motor has greater reference significance, and the reactive current mean value is more accurate.

In some embodiments, when the first output voltage corresponding to the target frequency is used to drive the permanent magnet synchronous motor to operate, a rated back emf voltage of the permanent magnet synchronous motor may be acquired, then the first output voltage corresponding to the target frequency is determined according to a linear relationship between the rated operating frequency and the rated back emf voltage, and the first output voltage is used to drive the permanent magnet synchronous motor to operate, wherein the first output voltage is less than or equal to the rated back emf voltage.

The rated back emf voltage of the permanent magnet synchronous motor is acquired; specifically, the rated back emf voltage of the permanent magnet synchronous motor may be calculated automatically according to nameplate data of the permanent magnet synchronous motor inputted to the frequency converter, in which case the rated back emf voltage is a rated input voltage of the permanent magnet synchronous motor.

The first output voltage corresponding to the target frequency is determined according to the linear relationship between the rated operating frequency and the rated back emf voltage; since a linear relationship, specifically a directly proportional relationship exists between the rated operating frequency and the rated back emf voltage, the ratio of the rated operating frequency to the rated back emf voltage is a fixed constant, for example: the rated operating frequency is 50 Hz, and the rated back emf voltage is 300 V, so if the target frequency is 10 Hz at this time, then an input voltage of the permanent magnet synchronous motor is 60 V, i.e. the first output voltage of the frequency converter is 60 V.

If the input voltage of the permanent magnet synchronous motor exceeds the rated back emf voltage, this is likely to cause damage to the permanent magnet synchronous motor, so the target frequency is less than or equal to the rated operating frequency, and the input voltage of the permanent magnet synchronous motor is less than or equal to the rated back emf voltage, i.e. the first output voltage of the frequency converter is less than or equal to the rated back emf voltage.

In some embodiments, the first output voltage corresponding to the target frequency is determined according to the linear relationship between the rated operating frequency and the rated back emf voltage of the permanent magnet synchronous motor, and the permanent magnet synchronous motor is driven to operate by means of the first output voltage, so that the permanent magnet synchronous motor operates at the target frequency. Since the permanent magnet synchronous motor is driven to operate by controlling the first output voltage, the permanent magnet synchronous motor is controlled by independent voltage control, and control accuracy is higher than when the permanent magnet synchronous motor is driven with a V/F control method.

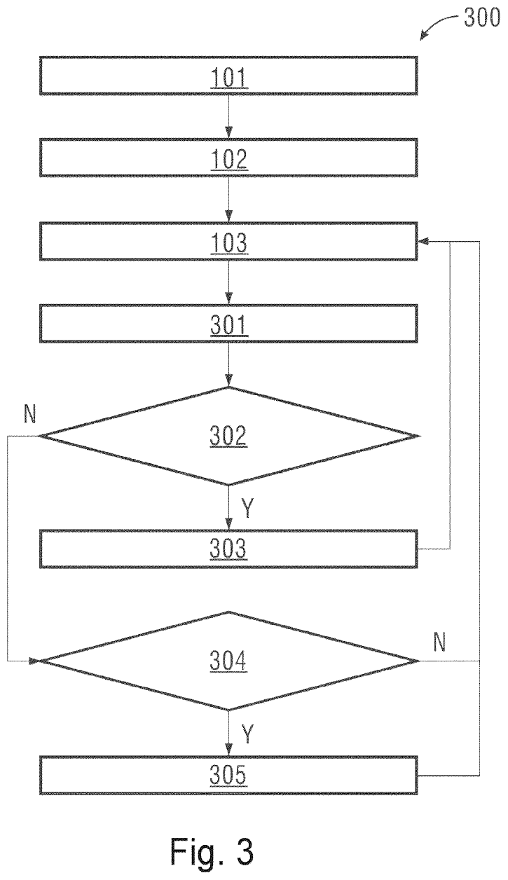

FIG. 3 is a flow chart of an example motor control method incorporating teachings of the present disclosure. As shown in FIG. 3, referencing 101-104 shown in FIGS. 1, 104 comprises the following 301-303:

Step 301: calculating the difference between the first reactive current value and the reactive current mean value.

Step 302: judging whether the difference between the first reactive current value and the reactive current mean value is greater than a first threshold; if yes (Y), performing step 303, and if no (N), performing step 304.

Step 303: reducing the first output voltage to obtain a second output voltage, and using the second output voltage to drive the permanent magnet synchronous motor to operate, and performing step 103. When the difference between the first reactive current value and the reactive current mean value is greater than the first threshold, the first output voltage is reduced; the input current and input voltage of the permanent magnet synchronous motor can thus be reduced, and the second output voltage obtained by reducing the first output voltage is used to drive the permanent magnet synchronous motor to operate, and step 103 of detecting a first reactive current value during operation of the permanent magnet synchronous motor is performed again, so as to perform steps 301-303 again; and this cycle is repeated.

Step 304: judging whether the difference between the first reactive current value and the reactive current mean value is less than a second threshold; if yes (Y), performing step 305, and if no (N), performing step 103.

Step 305: increasing the first output voltage to obtain a second output voltage, and using the second output voltage to drive the permanent magnet synchronous motor to operate, and performing step 103. When the difference between the first reactive current value and the reactive current mean value is less than the second threshold, the first output voltage is increased; the input current and input voltage of the permanent magnet synchronous motor can thus be increased, and the second output voltage obtained by increasing the first output voltage is used to drive the permanent magnet synchronous motor to operate, and step 103 of detecting a first reactive current value during operation of the permanent magnet synchronous motor is performed again, so as to perform 301-303 again; and this cycle is repeated.

When the difference between the first reactive current value and the reactive current mean value is less than the first threshold and greater than the second threshold, e.g. the difference between the first reactive current value and the reactive current mean value lies within a preset range of fluctuation, the first output voltage is not changed, and is determined to be the second output voltage, and the second output voltage is used to drive the permanent magnet synchronous motor to operate. The range of fluctuation is [first threshold, second threshold].

This embodiment is explained below, taking as an example the case where the first threshold is +0.05, the second threshold is −0.05, and the preset range of fluctuation is [−0.05, +0.05].

When I₁<I₀−0.05, i.e. I₁−I₀<−0.05, the first output voltage is increased to obtain the second output voltage, and the second output voltage is used to drive the permanent magnet synchronous motor to operate, and the step of detecting a first reactive current value arising when the second output voltage is used to drive the permanent magnet synchronous motor to operate is performed again, wherein \hat{ }, \hat{ } is used to represent the first reactive current value, and \hat{ }, \hat{ } is used to represent the reactive current mean value.

When I₁>I₀+0.05, i.e. I₁−I₀>+0.05, the first output voltage is reduced to obtain the second output voltage, and the second output voltage is used to drive the permanent magnet synchronous motor to operate, and the step of detecting a first reactive current value arising when the second output voltage is used to drive the permanent magnet synchronous motor to operate is performed again.

When I₀−0.05<I₁<I₀+0.05, i.e. −0.05<I₁−I₀<+0.05, the first output voltage is determined to be the second output voltage, and the second output voltage is used to drive the permanent magnet synchronous motor to operate.

It should be understood that the process described above is only one example, and does not limit the teachings of the present disclosure in any way; specifically, the first threshold, the second threshold and the preset range of fluctuation may be set according to the operating stability requirement of the permanent magnet synchronous motor.

In some embodiments, the first output voltage is adjusted according to the difference between the first reactive current value and the reactive current mean value to obtain the second output voltage, and the second output voltage is used to drive the permanent magnet synchronous motor to operate. In this way, the permanent magnet synchronous motor can be controlled to find the optimum operating point automatically, reducing the difficulty of adjustment/testing. When the load changes, the output voltage can be adjusted dynamically, preventing the permanent magnet synchronous motor from falling out of step due to load changes, and increasing the operating stability of the permanent magnet synchronous motor; thus, the motor control method is more practical.

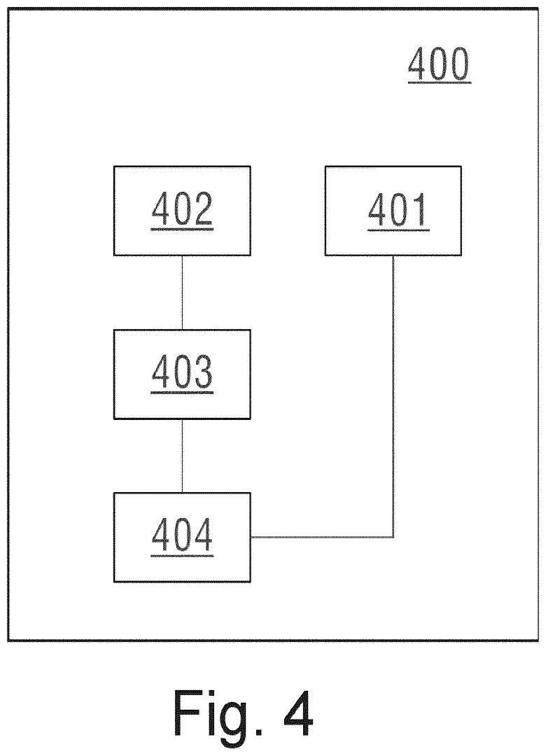

FIG. 4 is a schematic drawing of an example motor control apparatus incorporating teachings f the present disclosure. As shown in FIG. 4, a motor control apparatus 400 comprises: an acquisition unit 401, for acquiring a reactive current mean value of a permanent magnet synchronous motor; a first drive unit 402, for using a first output voltage corresponding to a target frequency to drive the permanent magnet synchronous motor to operate; a detection unit 403, for detecting a first reactive current value during operation of the permanent magnet synchronous motor; and a second drive unit 404, for adjusting the first output voltage according to the first reactive current value and the reactive current mean value to obtain a second output voltage and using the second output voltage to drive the permanent magnet synchronous motor to operate.

In some embodiments, the acquisition unit 401 may be used to perform step 101 in the method embodiments above, the first drive unit 402 may be used to perform step 102 in the method embodiments above, the detection unit 403 may be used to perform step 103 in the method embodiments above, and the second drive unit 404 may be used to perform step 104 in the method embodiments above.

In some embodiments, the acquisition unit 401 may be used to acquire a rated operating frequency of the permanent magnet synchronous motor; control the permanent magnet synchronous motor to operate at a first frequency, wherein the ratio of the first frequency to the rated operating frequency is a preset ratio threshold less than or equal to 1; detect a reactive current of the permanent magnet synchronous motor, to obtain at least two second reactive current values; and determine a mean value of the at least two second reactive current values to be the reactive current mean value.

In some embodiments, the ratio threshold is 1/2.

In some embodiments, the acquisition unit 401 may be used to acquire a rated back emf voltage of the permanent magnet synchronous motor; determine the first output voltage corresponding to the target frequency according to a linear relationship between the rated operating frequency and the rated back emf voltage; and use the first output voltage to drive the permanent magnet synchronous motor to operate, wherein the first output voltage is less than or equal to the rated back emf voltage.

In some embodiments, if the difference between the first reactive current value and the reactive current mean value lies within a preset range of fluctuation, the second drive unit 404 may determine the first output voltage to be the second output voltage, and use the second output voltage to drive the permanent magnet synchronous motor to operate.

In some embodiments, if the difference between the first reactive current value and the reactive current mean value is greater than a first threshold, the second drive unit 404 may reduce the first output voltage to obtain the second output voltage, and use the second output voltage to drive the permanent magnet synchronous motor to operate.

In some embodiments, if the difference between the first reactive current value and the reactive current mean value is less than a second threshold, the second drive unit 404 may increase the first output voltage to obtain the second output voltage, and use the second output voltage to drive the permanent magnet synchronous motor to operate.

Content such as processes of execution and exchange of information between the modules in the motor control apparatus is based on the same concept as the motor control method embodiments above, so for specific content, reference may be made to the information related in the motor control method embodiments above, which is not repeated here.

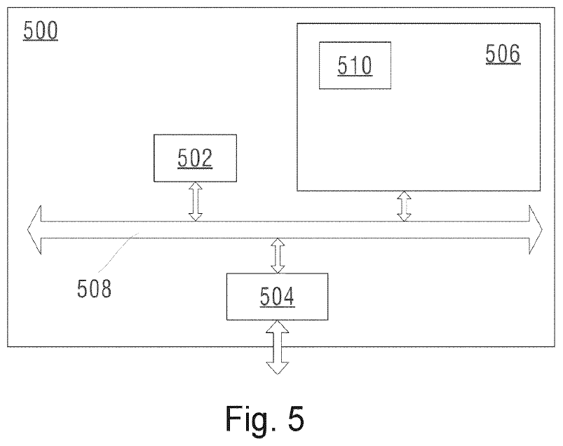

FIG. 5 is a schematic drawing of an example electronic device incorporating teachings of the present disclosure. The specific embodiments described herein do not limit the specific implementation of the electronic devices. Referring to FIG. 5, the electronic device 500 comprises: a processor 502, a communication interface 504, a memory 506 and a communication bus 508.

Here: The processor 502, the communication interface 504 and the memory 506 communicate with each other via the communication bus 508. The communication interface 504 is configured to communicate with other electronic devices or servers. The processor 502 is configured to execute a program 510, and specifically may perform the relevant steps in any of the motor control method embodiments above.

Specifically, the program 510 may comprise program code, which comprises computer operation instructions.

The processor 502 may be a central processing unit (CPU), or an application specific integrated circuit (ASIC), or one or more integrated circuit configured to implement the embodiments of the present application. One or more processors comprised in a smart device may be of the same type, for example, one or more CPUs; or of different types, for example, one or more CPUs and one or more ASICS.

The memory 506 is configured to store the program 510. The memory 506 may comprise a high-speed RAM, and may further comprise a non-volatile memory, for example, at least one magnetic disk memory.

The program 510 may specifically be configured to cause the processor 502 to perform the motor control method in any of the embodiments above.

For the specific implementation of the steps in the program 510, reference may be made to the corresponding limitations in any of the motor control method embodiments above and the corresponding descriptions in the units, which are not described again here. Those skilled in the art will clearly understand that, for convenience and simplicity of description, for the specific operation processes of the device and modules described above, reference may be made to the descriptions of corresponding processes in the method embodiments above, which are not repeated here.

In some embodiments, a first output voltage is used to drive a permanent magnet synchronous motor to operate, and in this way, independent voltage control of the permanent magnet synchronous motor is possible. The permanent magnet synchronous motor can be controlled more accurately to operate at a target frequency, and the first output voltage is adjusted according to a first reactive current detected during operation of the permanent magnet synchronous motor and an acquired reactive current mean value; thus, a drive voltage of the permanent magnet synchronous motor can be adjusted, so that the operation of the permanent magnet synchronous motor is more stable. Since a non-vector control method is used to drive the permanent magnet synchronous motor, the cost is lower, and when the load changes, the output voltage (i.e. the drive voltage of the permanent magnet synchronous motor) can be changed automatically according to the reactive current value produced by the permanent magnet synchronous motor. Thus, the permanent magnet synchronous motor can be prevented from falling out of step, and stability is higher, so the motor control method is more practical.

Some embodiments include a computer-readable storage medium, storing instructions for causing a machine to perform one or more of the motor control methods as described herein. Specifically, a system or apparatus equipped with a storage medium may be provided; software program code realizing functions of any one of the embodiments above is stored on the storage medium, and a computer (or CPU or MPU) of the system or apparatus is caused to read and execute program code stored in the storage medium.

In this case, the program code read from the storage medium can itself implement the functions of any of the embodiments described above, and therefore the program code and the storage medium storing the program code constitute part of the present application.

Embodiments of storage media used for providing the program code include floppy disks, hard disks, magneto-optical disks, optical disks (such as CD-ROM, CD-R, CD-RW, DVD-ROM, DVD-RAM, DVD-RW, DVD+RW), magnetic tapes, non-volatile memory cards and ROM. Optionally, the program code may be downloaded from a server computer via a communication network. An operating system, etc. operating on a computer can be made to complete part or all of actual operations, not only through execution of the program code read by a computer, but also by means of instructions based on the program code, so as to realize functions of any one of the embodiments above.

The program code read from the storage medium is written into a memory provided in an expansion board inserted into a computer or written into a memory provided in an expansion module connected to a computer, and then based on the instruction of the program code, a CPU, etc. installed on the expansion board or the expansion module is made to perform part or all of the actual operations, thereby implementing the functions of any of the embodiments described above.

Embodiments of the present application further provide a computer program product, stored on a tangible computer-readable medium and including computer-executable instructions which, when executed, cause at least one processor to perform the motor control method provided in the above embodiments. It should be understood that the solutions in such embodiment have the corresponding technical effects in the method embodiments described above, which will not be detailed here.

Not all of the steps and modules in the flows and system structure diagrams above are necessary; certain steps or modules may be omitted according to actual requirements. The sequence in which the steps are executed is not fixed and may be adjusted as needed. The system structures described in the embodiments above may be physical structures or logical structures, e.g., some modules might be realized by the same physical entity, or some modules might be realized by multiple physical entities or realized jointly by certain components in multiple independent devices.

A noun or pronoun referring to a person in the present patent application is not limited to a specific gender.

A hardware module may be realized in a mechanical or an electrical manner. For example, a hardware module may comprise permanent dedicated circuitry or logic (for example, a dedicated processor, an FPGA or an ASIC) to perform corresponding operations. The hardware module may further comprise programmable logic or circuitry (for example, a general-purpose processor or other programmable processor), which may be temporarily configured by software to complete corresponding operations. Particular implementations (mechanical, or dedicated permanent circuitry, or temporarily set circuitry) may be determined based on considerations of cost and time.

The teachings of the present disclosure are demonstrated and described in detail in conjunction with the drawings and example embodiments, but the teachings herein are not limited to these disclosed embodiments. Those skilled in the art can understand that more embodiments can be obtained by combining the code review means in different embodiments described above based on the various embodiments above, and these embodiments also fall within the scope of protection of the present disclosure.

What is claimed is:

1. A motor control method comprising:
acquiring a reactive current mean value of a permanent magnet synchronous motor;
using a first output voltage corresponding to a target frequency to drive the permanent magnet synchronous motor to operate;
detecting a first reactive current value during operation of the permanent magnet synchronous motor;
adjusting the first output voltage according to the first reactive current value and the reactive current mean value to obtain a second output voltage; and
using the second output voltage to drive the permanent magnet synchronous motor to operate.

2. The method as claimed in claim 1, wherein acquiring a reactive current mean value of a permanent magnet synchronous motor comprises:
acquiring a rated operating frequency of the permanent magnet synchronous motor;
controlling the permanent magnet synchronous motor to operate at a first frequency, wherein the ratio of the first frequency to the rated operating frequency is a preset ratio threshold less than or equal to 1;
detecting a reactive current of the permanent magnet synchronous motor, to obtain at least two second reactive current values; and
determining a mean value of the at least two second reactive current values to be the reactive current mean value.

3. The method as claimed in claim 2, wherein the ratio threshold is 1/2.

4. The method as claimed in claim 2, wherein using a first output voltage corresponding to a target frequency to drive the permanent magnet synchronous motor to operate, comprises:
acquiring a rated back emf voltage of the permanent magnet synchronous motor;
determining the first output voltage corresponding to the target frequency according to a linear relationship between the rated operating frequency and the rated back emf voltage; and
using the first output voltage to drive the permanent magnet synchronous motor to operate;
wherein the first output voltage is less than or equal to the rated back emf voltage.

5. The method as claimed in claim 1, wherein adjusting the first output voltage according to the first reactive current value and the reactive current mean value to obtain a second output voltage and using the second output voltage to drive the permanent magnet synchronous motor to operate, comprises:
if the difference between the first reactive current value and the reactive current mean value lies within a preset range of fluctuation, determining the first output voltage to be the second output voltage, and using the second output voltage to drive the permanent magnet synchronous motor to operate.

6. The method as claimed in claim 1, wherein adjusting the first output voltage according to the first reactive current value and the reactive current mean value to obtain a second output voltage, and using the second output voltage to drive the permanent magnet synchronous motor to operate comprises:
if the difference between the first reactive current value and the reactive current mean value is greater than a first threshold, reducing the first output voltage to obtain the second output voltage, and using the second output voltage to drive the permanent magnet synchronous motor to operate.

7. The method as claimed in claim 1, wherein adjusting the first output voltage according to the first reactive current value and the reactive current mean value to obtain a second output voltage and using the second output voltage to drive the permanent magnet synchronous motor to operate, comprises:
if the difference between the first reactive current value and the reactive current mean value is less than a second threshold, increasing the first output voltage to obtain the second output voltage, and using the second output voltage to drive the permanent magnet synchronous motor to operate.

8. A motor control apparatus comprising:
an acquisition unit to acquire a reactive current mean value of a permanent magnet synchronous motor;
a first drive unit, to use a first output voltage corresponding to a target frequency to drive the permanent magnet synchronous motor to operate;
a detection unit to detect a first reactive current value during operation of the permanent magnet synchronous motor; and
a second drive unit to adjust the first output voltage according to the first reactive current value and the reactive current mean value to obtain a second output voltage and us the second output voltage to drive the permanent magnet synchronous motor to operate.

9. An electronic device comprising:
a processor;
a communication interface;
a memory; and
a communication bus providing communication between the processor, the memory, and the communication interface;
wherein the memory stores at least one executable instruction causing the processor to:
acquire a reactive current mean value of a permanent magnet synchronous motor;
use a first output voltage corresponding to a target frequency to drive the permanent magnet synchronous motor to operate;
detect a first reactive current value during operation of the permanent magnet synchronous motor;
adjust the first output voltage according to the first reactive current value and the reactive current mean value to obtain a second output voltage; and
use the second output voltage to drive the permanent magnet synchronous motor to operate.

10-11. (canceled)
